(19) United States
(12) Patent Application Publication
(10) Pub. No.: US 2021/0176385 A1
(43) Pub. Date: Jun. 10, 2021

(54) Camera Configuration For Active Stereo Without Image Quality Degradation

(71) Applicant: MediaTek Inc., Hsinchu City (TW)

(72) Inventor: I-Hsien Lee, Hsinchu City (TW)

(21) Appl. No.: 16/708,790

(22) Filed: Dec. 10, 2019

(51) Int. Cl. H04N 5/225; G06T 7/593; G06T 7/521; G06T 7/80

(52) U.S. Cl. CPC H04N 5/2258; G06T 7/80; G06T 7/521; G06T 7/593

(57) ABSTRACT

Various examples with respect to camera configuration for active stereo without image quality degradation are described. A first sensor and a second sensor are controlled to capture images of a scene. The first sensor is configured to sense light in a first spectrum. The second sensor is configured to sense light in both the first spectrum and a second spectrum different from the first spectrum. Depth information about the scene is then extracted from the images captured by the first sensor and the second sensor.

### TECHNICAL FIELD

The present disclosure is generally related to computer stereo vision and, more particularly, to techniques pertaining to camera configuration for active stereo without image quality degradation.

### BACKGROUND

Unless otherwise indicated herein, approaches described in this section are not prior art to the claims listed below and are not admitted as prior art by inclusion in this section.

Computer stereo vision is a technology that provides three-dimensional (3D) information from digital images of a scene. By comparing information about the scene from two digital images taken from two vantage points, 3D information can be obtained with stereo matching by comparing relative positions of objects in the two digital images of the scene. For instance, with a first image of the scene as a base, a correspondent patch may be identified in a second image of the scene. The further displacement of the correspondence patch between the first image and the second image, the closer an object in the scene is to the camera(s) capturing the images. However, there are some limitations associated with stereo matching. For example, pixels may be occluded and as a result stereo matching cannot be performed. As another example, an ambiguous matching result (e.g., due to low texture or repeated pattern) can lead to unreliable depth information. Moreover, although sophisticated depth algorithm is available, some of the limitations associated with stereo matching still cannot be avoided.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose schemes, solutions, concepts, designs, methods and apparatuses that address aforementioned issues. Specifically, various schemes, solutions, concepts, designs, methods and apparatuses proposed in the present disclosure pertain to camera configuration for active stereo without image quality degradation.

In one aspect, a method may involve controlling a first sensor and a second sensor to capture images of a scene. The method may also involve extracting depth information about the scene from the images. The first sensor may be configured to sense light in a first spectrum, and the second sensor may be configured to sense light in both the first spectrum and a second spectrum different from the first spectrum.

In another aspect, an apparatus may include a first sensor, a second sensor, and a control circuit coupled to the first sensor and the second sensor. The first sensor may be configured to sense light in a first spectrum. The second sensor may be configured to sense light in both the first spectrum and a second spectrum different from the first spectrum. The control circuit may be configured to control the first sensor and the second sensor to capture images of a scene. The control circuit may be also configured to extract depth information about the scene from the images.

It is noteworthy that, although description provided herein may be in the context of certain technologies, the proposed concepts, schemes and any variation(s)/derivative(s) thereof may be implemented in, for and by other technologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example scenario in which a proposed scheme in accordance with the present disclosure may be implemented.

FIG. 2 is a diagram of an example scenario in which a proposed scheme in accordance with the present disclosure may be implemented.

FIG. 3 is a diagram of an example apparatus in accordance with an implementation of the present disclosure.

FIG. 4 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

To address aforementioned issues, active three-dimensional (3D) sensing may be utilized to improve the accuracy in depth information and eliminate some of the limitations described above. In general, active 3D sensing can be achieved by using structured light or active stereo. Under the structured light approach, one infrared (IR) projector or emitter and one IR camera may be utilized to obtain depth information by deformation of light pattern(s) (e.g., dot pattern or stripe patter), hereinafter referred to as “Algorithm 1.” However, this approach cannot be employed or does not work well in a brightly-illuminated environment. Under the active stereo approach, one IR projector/emitter and two IR cameras may be utilized to obtain depth information by stereo matching, hereinafter referred to as “Algorithm 2.” When employed in a brightly-illuminated environment, however, active 3D sensing under the active stereo approach may fall back to a passive mode in which no projector/emitter is utilized (e.g., with the IR projector/emitter turned off).

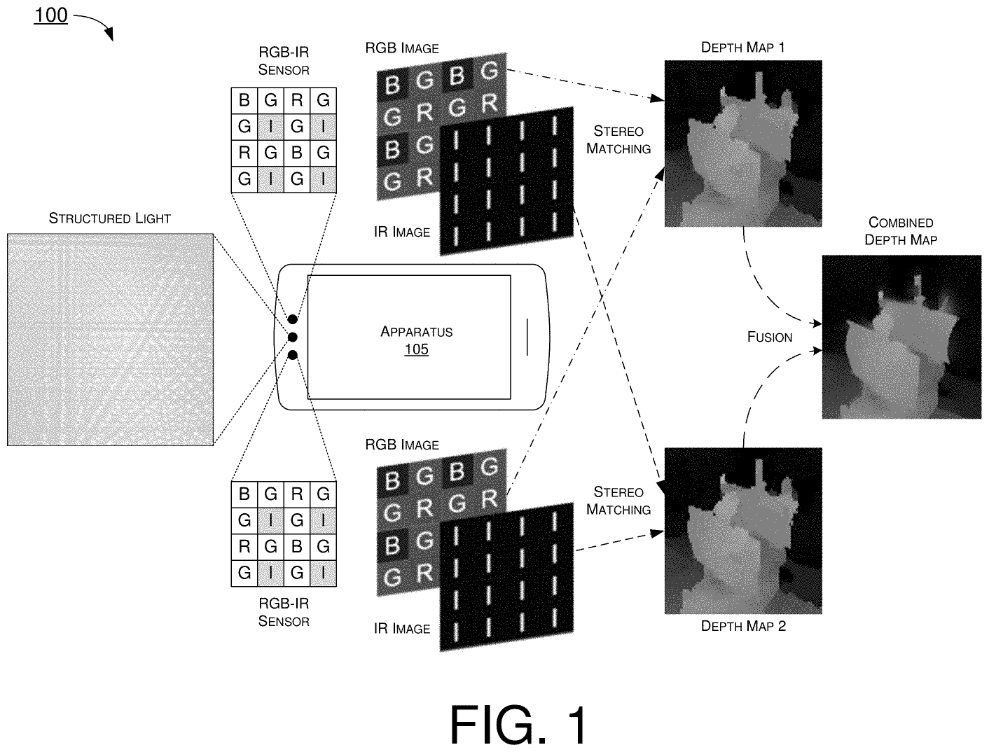

FIG. 1 illustrates an example scenario 100 in which a proposed scheme in accordance with the present disclosure may be implemented. Under the proposed scheme as shown in FIG. 1, two RGB-IR sensors or cameras may be utilized in active 3D sensing. For instance, special-designed color filter array (CFA) sensors may be utilized to record both visible light and IR light, and a special image signal processor (ISP) may reconstruct a red-green-blue (RGB) image from RGB-IR data from the sensors. Under the proposed scheme, each of the two RGB-IR sensors/cameras may be configured to sense light in the visible band or spectrum (e.g., light with a wavelength in the range of 380-740 nanometers (nm)) as well as the IR band or spectrum (e.g., light with a wavelength in the range of 750-1000 nm) and output two images (one in the visible band and the other in the IR band). Thus, when two RGB-IR sensors/cameras are utilized, four images of a scene may be generated, namely: a left RGB image in the visible band, a right RGB image in the visible band, a left IR image in the IR band, and a right IR image in the IR band. One of the two RGB-IR sensors/cameras may function as a main camera while the other may function as a shared depth sensing camera. Under the proposed scheme, Algorithm 2 (stereo matching) may be utilized for detection or estimation of depth of the scene to provide depth information. Specifically, stereo matching may be utilized to generate an RGB depth map using the left and right RGB images and an IR depth map using the left and right IR images. Then, fusion may be performed with the RGB depth map and the IR depth map to provide a combined depth map. Further processing may achieve computer stereo vision based on active 3D sensing using the combined depth map.

Referring to FIG. 1, an apparatus 105 may be equipped with two RGB-IR sensors each configured to sense light in the visible band and the IR band to respectively capture an RGB image and an IR image of a scene. Apparatus 105 may be also equipped with a light emitter (e.g., IR light projector) configured to provide a structured light toward the scene. First depth information such as a first depth map (denoted as “depth map 1” in FIG. 1) may be extracted from the RGB images captured by the two RGB-IR sensors using Algorithm 2 (stereo matching). Second depth information such as a second depth map (denoted as “depth map 2” in FIG. 1) may be extracted from the IR images captured by the two RGB-IR sensors using Algorithm 2 (stereo matching). The first depth information and second depth information may be fused or otherwise combined to result in a combined depth map, which may be utilized for computer stereo vision.

However, this proposed scheme is not without its shortcoming. For instance, due to different RGB-IR patterns designed by different sensor vendors, there may be distortion or degradation in the resultant RGB-IR image quality. Additionally, quality drop in the main camera may be unavoidable since some of the visible light sensing pixels are replaced with IR sensing pixels in the RGB-IR sensor.

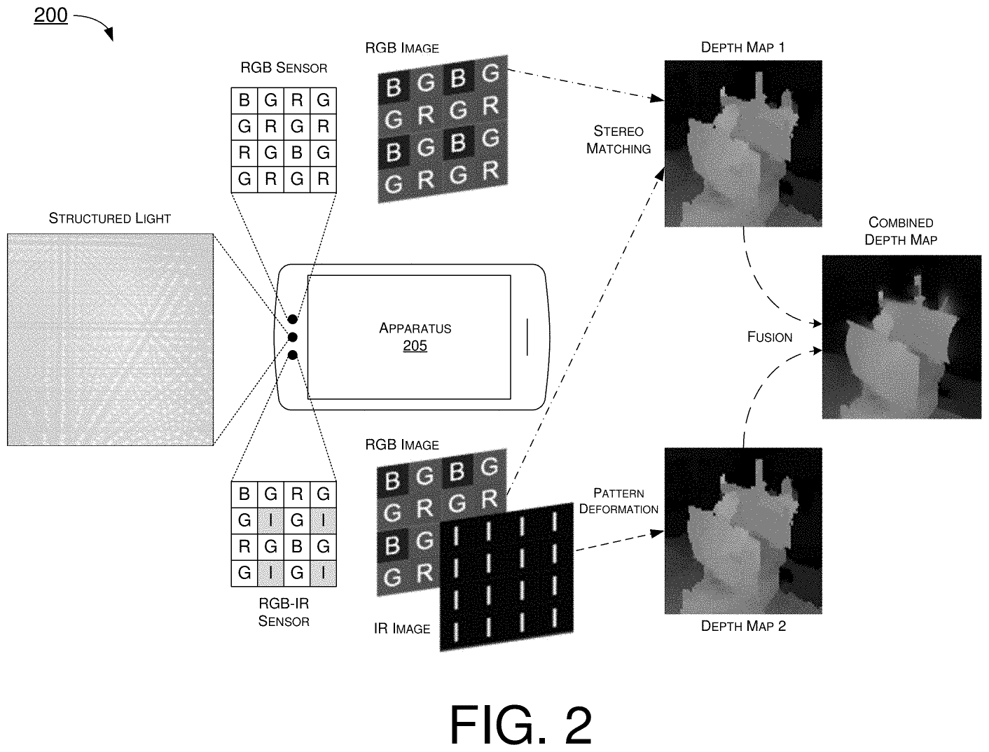

FIG. 2 illustrates an example scenario 200 in which a proposed scheme in accordance with the present disclosure may be implemented. Under the proposed scheme as shown in FIG. 2, one RGB sensor/camera and one RGB-IR sensor/camera may be utilized in active 3D sensing, with the RGB sensor/camera functioning as a main camera and the RGB-IR sensor/camera functioning as a shared depth sensing camera. Under the proposed scheme, Bayer pattern may be utilized for the RGB pixels of the RGB sensor/camera which functions as the main camera. The RGB-IR sensor/camera in scenario 200 may function as a sub-camera, the RGB information obtained by which may be used in conjunction with the RGB information obtained by the main camera for stereo matching (e.g., for outdoor applications). Thus, three images of a scene may be generated, namely: a first RGB image in the visible band, a second RGB image in the visible band, and an IR image in the IR band. Advantageously, quality in the RGB images captured by the main camera may be retained.

Under this proposed scheme, both Algorithm 1 (i.e., using structured light to obtain depth information by pattern deformation in IR image(s)) and Algorithm 2 (i.e., using active stereo to obtain depth information by stereo matching) may be utilized based on the two RGB images and one IR image to generate a resultant depth map of the scene. Accordingly, for any patch in the RGB images where there is repeated pattern(s) or no/low texture, depth information for that patch may still be obtained with the IR image using structured light (Algorithm 1), thereby enhancing performance in depth sensing.

Referring to FIG. 2, an apparatus 205 may be equipped with an RGB sensor and an RGB-IR sensor. The RGB sensor may be configured to sense light in the visible band to capture an RGB image of a scene. The RGB-IR sensor may be configured to sense light in the visible band and the IR band to capture an RGB image and an IR image of the scene. Apparatus 205 may be also equipped with a light emitter (e.g., IR light projector) configured to provide a structured light toward the scene. First depth information such as a first depth map (denoted as “depth map 1” in FIG. 2) may be extracted from the RGB images captured by the RGB sensor and the RGB-IR sensor using Algorithm 2 (stereo matching). Second depth information such as a second depth map (denoted as “depth map 2” in FIG. 2) may be extracted from the IR image captured by the RGB-IR sensor using Algorithm 1 (pattern deformation). The first depth information and second depth information may be fused or otherwise combined to result in a combined depth map, which may be utilized for computer stereo vision.

Thus, an optimized camera combination is proposed, as shown in FIG. 2 (e.g., using a special ISP designed to include an RGB-IR sensor). In scenario 200, two heterogeneous depth extraction algorithms or techniques are employed in a single platform to provide depth information for active 3D sensing. Advantageously, it is believed that there is no quality degradation in captured images. Moreover, the proposed scheme may be suitable for both indoor and outdoor applications. Furthermore, the proposed scheme utilizes a relatively small number of cameras (e.g., two cameras) compared to other approaches, which may utilize three or more cameras and hence end to be more costly.

### Illustrative Implementations

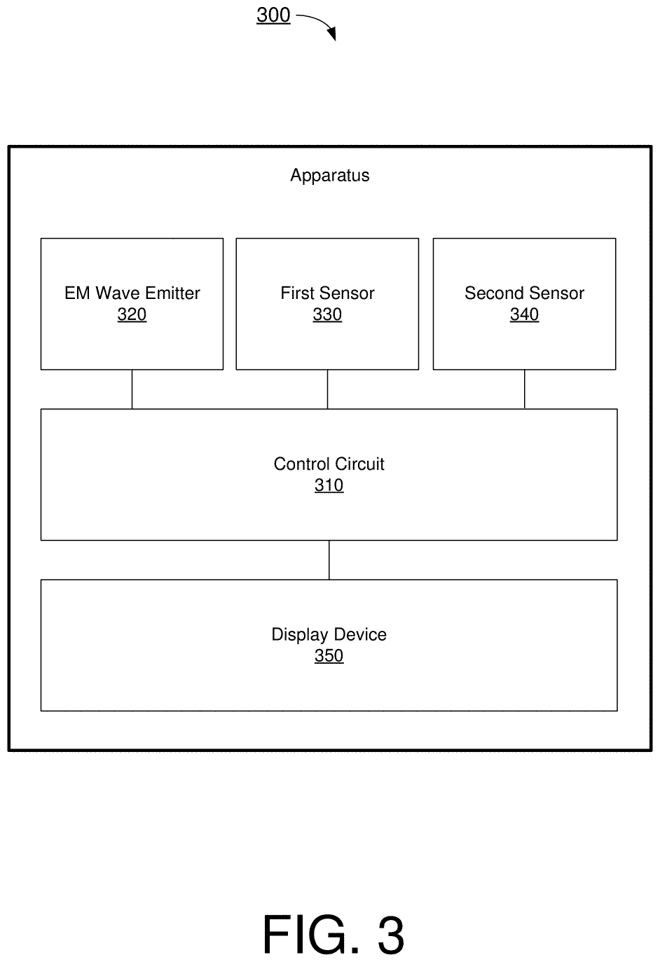

FIG. 3 illustrates an example apparatus 300 in accordance with an implementation of the present disclosure. Apparatus 300 may perform various functions to implement procedures, schemes, techniques, processes and methods described herein pertaining to camera configuration for active stereo without image quality degradation, including the various procedures, scenarios, schemes, solutions, concepts and techniques described above with respect to scenarios described above as well as process(s) described below. Apparatus 300 may be an example implementation of apparatus 205 in scenario 200.

Apparatus 300 may be a part of an electronic apparatus, a portable or mobile apparatus, a wearable apparatus, a wireless communication apparatus or a computing apparatus. For instance, apparatus 300 may be implemented in a smartphone, a smartwatch, a personal digital assistant, a digital camera, or a computing equipment such as a tablet computer, a laptop computer or a notebook computer. Moreover, apparatus 300 may also be a part of a machine type apparatus, which may be an Internet-of-Things (IoT) or narrowband (NB)-IoT apparatus such as an immobile or a stationary apparatus, a home apparatus, a wire communication apparatus or a computing apparatus. For instance, apparatus 300 may be implemented in a smart thermostat, a smart fridge, a smart door lock, a wireless speaker or a home control center. Alternatively, apparatus 300 may be implemented in the form of one or more integrated-circuit (IC) chips such as, for example and without limitation, one or more single-core processors, one or more multi-core processors, one or more reduced-instruction-set-computing (RISC) processors or one or more complex-instruction-set-computing (CISC) processors.

Apparatus 300 may include at least some of those components shown in FIG. 3 such as a control circuit 310, at least one electromagnetic (EM) wave emitter 320, a first sensor 330 and a second sensor 340. Optionally, apparatus 300 may also include a display device 350. Control circuit 310 may be coupled to otherwise in communication with each of EM wave emitter 320, first sensor 330, second sensor 340 and display device 350 to control operations thereof. Apparatus 300 may further include one or more other components not pertinent to the proposed scheme of the present disclosure (e.g., internal power supply, memory device and/or user interface device), and, thus, such component(s) of apparatus 300 are neither shown in FIG. 3 nor described below in the interest of simplicity and brevity.

In one aspect, control circuit 310 may be implemented in the form of an electronic circuit comprising various electronic components. Alternatively, control circuit 310 may be implemented as part of or in the form of one or more single-core processors, one or more multi-core processors, one or more RISC processors, or one or more CISC processors. That is, even though a singular term “a processor” is used herein to refer to control circuit 310, control circuit 310 may include multiple processors in some implementations and a single processor in other implementations in accordance with the present disclosure. In another aspect, apparatus 310 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, control circuit 310 is a special-purpose machine specifically designed, arranged and configured to perform specific tasks pertaining to camera configuration for active stereo without image quality degradation in accordance with various implementations of the present disclosure. In some implementations, control circuit 310 may include an electronic circuit with hardware components implementing one or more of the various proposed schemes in accordance with the present disclosure. Alternatively, other than hardware components, control circuit 310 may also utilize software codes and/or instructions in addition to hardware components to implement camera configuration for active stereo without image quality degradation in accordance with various implementations of the present disclosure.

Under various proposed schemes in accordance with the present disclosure, first sensor 330 may be configured to sense light in a first spectrum, and second sensor 340 may be configured to sense light in both the first spectrum and a second spectrum different from the first spectrum. Control circuit 310 may be configured to control EM wave emitter 320 to project a structured light toward a scene. Control circuit 310 may also be configured to control first sensor 330 and second sensor 340 to capture images of the scene. Control circuit 310 may be further configured to extract depth information about the scene from the images.

In some implementations, first sensor 330 may include an RGB sensor configured to sense light in a visible band, and second sensor 340 may include an RGB-IR sensor configured to sense light in the visible band and an IR band. In some implementations, at least one of the RGB sensor and the RGB-IR sensor comprises a color filter array (CFA) with RGB color filters arranged in a pattern as a Bayer filter mosaic.

In some implementations, in extracting the depth information about the scene from the images, control circuit 310 may be configured to extract the depth information about the scene from the images by using heterogeneous techniques. In some implementations, in extracting the depth information about the scene from the images by using the heterogeneous techniques, control circuit 310 may be configured to extract the depth information about the scene by using a first technique based on a first image captured by first sensor 330 and a second image captured by second sensor 340 in the first spectrum and by using a second technique based on a third image captured by second sensor 340 in the second spectrum. In such cases, the first technique may include obtaining first depth information based on stereo matching, and the second technique may include obtaining second depth information based on pattern deformation using a structured light.

In some implementations, in extracting the depth information about the scene from the images, control circuit 310 may be configured to extract the depth information about the scene from the images by using a single technique based on a first image captured by first sensor 330 and a second image captured by second sensor 340 in the first spectrum. In such cases, the single technique may include obtaining the depth information based on stereo matching.

In some implementations, in extracting the depth information about the scene, control circuit 310 may be configured to perform certain operations. For instance, control circuit 310 may obtain first depth information based on a first image captured by first sensor 330 and a second image captured by second sensor 340 in the first spectrum. Additionally, control circuit 310 may obtain second depth information based on a third image captured by second sensor 340 in the second spectrum. Moreover, control circuit 310 may fuse or otherwise combine the first depth information and the second depth information to generate a combined result as the depth information.

### Illustrative Processes

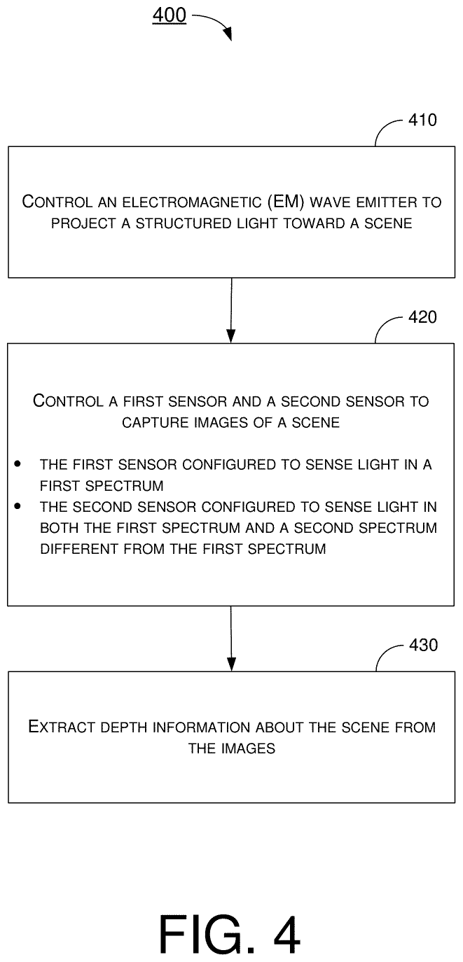

FIG. 4 illustrates an example process 400 in accordance with an implementation of the present disclosure. Process 400 may be an example implementation of the various procedures, scenarios, schemes, solutions, concepts and techniques, or a combination thereof, whether partially or completely, with respect to camera configuration for active stereo without image quality degradation in accordance with the present disclosure. Process 400 may represent an aspect of implementation of features of apparatus 300. Process 400 may include one or more operations, actions, or functions as illustrated by one or more of blocks 410, 420 and 430. Although illustrated as discrete blocks, various blocks of process 400 may be divided into additional blocks, combined into fewer blocks, or eliminated, depending on the desired implementation. Moreover, the blocks of process 400 may executed in the order shown in FIG. 4 or, alternatively, in a different order. Furthermore, one or more of the blocks of process 400 may be repeated one or more times. Process 400 may be implemented by apparatus 300 or any variation thereof. Solely for illustrative purposes and without limitation, process 400 is described below in the context of apparatus 300. Process 400 may begin at block 410.

At 410, process 400 may involve control circuit 310 controlling EM wave emitter 320 to project a structured light toward a scene. Process 400 may proceed from 410 to 420.

At 420, process 400 may involve control circuit 310 controlling first sensor 330 and second sensor 340 to capture images of the scene, with first sensor 330 configured to sense light in a first spectrum and with second sensor 340 configured to sense light in both the first spectrum and a second spectrum different from the first spectrum. Process 400 may proceed from 420 to 430.

At 430, process 400 may involve control circuit 310 extracting depth information about the scene from the images.

In some implementations, first sensor 330 may include an RGB sensor configured to sense light in a visible band, and second sensor 340 may include an RGB-IR sensor configured to sense light in the visible band and an IR band. In some implementations, at least one of the RGB sensor and the RGB-IR sensor comprises a color filter array (CFA) with RGB color filters arranged in a pattern as a Bayer filter mosaic.

In some implementations, in extracting the depth information about the scene from the images, process 400 may involve control circuit 310 extracting the depth information about the scene from the images by using heterogeneous techniques. In some implementations, in extracting the depth information about the scene from the images by using the heterogeneous techniques, process 400 may involve control circuit 310 extracting the depth information about the scene by using a first technique based on a first image captured by first sensor 330 and a second image captured by second sensor 340 in the first spectrum and by using a second technique based on a third image captured by second sensor 340 in the second spectrum. In such cases, the first technique may include obtaining first depth information based on stereo matching, and the second technique may include obtaining second depth information based on pattern deformation using a structured light.

In some implementations, in extracting the depth information about the scene from the images, process 400 may involve control circuit 310 extracting the depth information about the scene from the images by using a single technique based on a first image captured by first sensor 330 and a second image captured by second sensor 340 in the first spectrum. In such cases, the single technique may include obtaining the depth information based on stereo matching.

In some implementations, in extracting the depth information about the scene, process 400 may involve control circuit 310 performing certain operations. For instance, process 400 may involve control circuit 310 obtaining first depth information based on a first image captured by first sensor 330 and a second image captured by second sensor 340 in the first spectrum. Additionally, process 400 may involve control circuit 310 obtaining second depth information based on a third image captured by second sensor 340 in the second spectrum. Moreover, process 400 may involve control circuit 310 fusing or otherwise combining the first depth information and the second depth information to generate a combined result as the depth information.

### ADDITIONAL NOTES

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
controlling a first sensor and a second sensor to capture images of a scene; and
extracting depth information about the scene from the images,
wherein the first sensor is configured to sense light in a first spectrum, and
wherein the second sensor is configured to sense light in both the first spectrum and a second spectrum different from the first spectrum.

2. The method of claim 1, wherein the controlling of the first sensor and the second sensor to capture the images of the scene comprises controlling a red-green-blue (RGB) sensor and an RGB-infrared (RGB-IR) sensor to capture the images of the scene, wherein the RGB sensor is configured to sense light in a visible band, and wherein the RGB-IR sensor is configured to sense light in the visible band and an IR band.

3. The method of claim 2, wherein at least one of the RGB sensor and the RGB-IR sensor comprises a color filter array (CFA) with RGB color filters arranged in a pattern as a Bayer filter mosaic.

4. The method of claim 1, wherein the extracting of the depth information about the scene from the images comprises extracting the depth information about the scene from the images by using heterogeneous techniques.

5. The method of claim 4, wherein the extracting of the depth information about the scene from the images by using the heterogeneous techniques comprises extracting the depth information about the scene by using a first technique based on a first image captured by the first sensor and a second image captured by the second sensor in the first spectrum and by using a second technique based on a third image captured by the second sensor in the second spectrum.

6. The method of claim 5, wherein the first technique comprises obtaining first depth information based on stereo matching, and wherein the second technique comprises obtaining second depth information based on pattern deformation using a structured light.

7. The method of claim 1, wherein the extracting of the depth information about the scene from the images comprises extracting the depth information about the scene from the images by using a single technique based on a first image captured by the first sensor and a second image captured by the second sensor in the first spectrum.

8. The method of claim 7, wherein the single technique comprises obtaining the depth information based on stereo matching.

9. The method of claim 1, wherein the extracting of the depth information about the scene comprises:
obtaining first depth information based on a first image captured by the first sensor and a second image captured by the second sensor in the first spectrum;
obtaining second depth information based on a third image captured by the second sensor in the second spectrum; and
fusing the first depth information and the second depth information to generate a combined result as the depth information.

10. The method of claim 1, further comprising:
controlling an electromagnetic (EM) wave emitter to project a structured light toward the scene.

11. An apparatus, comprising:
a first sensor configured to sense light in a first spectrum;
a second sensor configured to sense light in both the first spectrum and a second spectrum different from the first spectrum; and
a control circuit coupled to the first sensor and the second sensor, the control circuit configured to perform operations comprising:
controlling the first sensor and the second sensor to capture images of a scene; and
extracting depth information about the scene from the images.

12. The apparatus of claim 11, wherein the first sensor comprises a red-green-blue (RGB) sensor configured to sense light in a visible band, and wherein the second sensor comprises an RGB-infrared (RGB-IR) sensor configured to sense light in the visible band and an IR band.

13. The apparatus of claim 12, wherein at least one of the RGB sensor and the RGB-IR sensor comprises a color filter array (CFA) with RGB color filters arranged in a pattern as a Bayer filter mosaic.

14. The apparatus of claim 11, wherein, in extracting the depth information about the scene from the images, the control circuit is configured to extract the depth information about the scene from the images by using heterogeneous techniques.

15. The apparatus of claim 14, wherein, in extracting the depth information about the scene from the images by using the heterogeneous techniques, the control circuit is configured to extract the depth information about the scene by using a first technique based on a first image captured by the first sensor and a second image captured by the second sensor in the first spectrum and by using a second technique based on a third image captured by the second sensor in the second spectrum.

16. The apparatus of claim 15, wherein the first technique comprises obtaining first depth information based on stereo matching, and wherein the second technique comprises obtaining second depth information based on pattern deformation using a structured light.

17. The apparatus of claim 11, wherein, in extracting the depth information about the scene from the images, the control circuit is configured to extract the depth information about the scene from the images by using a single technique based on a first image captured by the first sensor and a second image captured by the second sensor in the first spectrum.

18. The apparatus of claim 17, wherein the single technique comprises obtaining the depth information based on stereo matching.

19. The apparatus of claim 11, wherein, in extracting the depth information about the scene, the control circuit is configured to perform operations comprising:
obtaining first depth information based on a first image captured by the first sensor and a second image captured by the second sensor in the first spectrum;
obtaining second depth information based on a third image captured by the second sensor in the second spectrum; and
fusing the first depth information and the second depth information to generate a combined result as the depth information.

20. The apparatus of claim 11, further comprising:
an electromagnetic (EM) wave emitter,
wherein the control circuit is configured to control the EM wave emitter to project a structured light toward the scene.
